(19) United States
(12) Patent Application Publication
(10) Pub. No.: US 2005/0213482 A1
(43) Pub. Date: Sep. 29, 2005

(54) Multi-track mastering techniques

(75) Inventor: Jathan D. Edwards, Afton, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/807,822

(22) Filed: Mar. 24, 2004

(51) Int. Cl. G11B 7/24

(52) U.S. Cl. 369/275.4

(57) ABSTRACT

Mastering techniques are described that can improve the quality of a master used in data storage disk manufacturing. In particular, multi-spot mastering techniques and interferometric mastering techniques are described. The techniques described can reduce track pitch variations between adjacent tracks of the master. Also, the techniques may provide improved consistency in the features created on the master.

### TECHNICAL FIELD

The invention relates to manufacturing techniques for creation of data storage disks.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase change optical disks, and others. Some newer formats for optical data storage disks are progressing toward smaller disk sizes and increased data storage density. A wide variety of optical data storage disk standards have been developed, and other standards will continue to emerge.

Optical data storage disks are typically produced by first making a data storage disk master that has a surface pattern that represents encoded data on the master surface. The surface pattern, for instance, may be a collection of grooves or other features that define master pits and master lands in either a spiral or concentric pattern. The master is typically not suitable as a mass replication surface, with the master features being defined within an etched photoresist layer that is formed over a master substrate.

After creating a suitable master, that master can be used to make a stamper, which is less fragile than the master. The stamper is typically formed of electroplated metal or a hard plastic material, and has a surface pattern that is the inverse of the surface pattern encoded on the master. The stamper can be used in an injection mold to fabricate large quantities of replica disks. Also, stampers have been used in rolling bead processes to fabricate replica disks. In any case, each replica disk may contain the data and tracking information that was originally encoded on the master surface. The replica disks can be coated with a reflective layer and/or a phase change layer, and are often sealed with an additional protective layer. Other media formats, such as magnetic disk formats, may also use similar mastering-stamping techniques, e.g., to create media having small surface features which correspond to magnetic domains.

In some cases, the surface pattern encoded on the data storage disk master represents an inverse of the desired replica disk pattern. In those cases, the master is typically used to create a first-generation stamper, which is in turn used to create a second-generation stamper. The second-generation stamper, then, can be used to create replica disks that contain an inverse of the surface pattern encoded on the master. Creating multiple generations of stampers can also allow for improved replica disk productivity from a single data storage disk master.

The mastering process is one of the most critical stages of the data storage disk manufacturing process. In particular, the mastering process defines the surface pattern to be created in replica disks. Any variations or irregularities in the master will be passed on to stampers and replica disks, so the creation of a high quality master is essential to the creation of high quality replica disks. For this reason, it is highly desirable to improve mastering techniques.

The mastering process commonly uses a photolithographic process to define the master surface pattern. To facilitate the mastering process, an optically flat master substrate is coated with a layer of photoresist. A tightly focused laser beam is then passed over the photoresist-coated substrate to expose grooves or other latent features in the photoresist, which may be categorized as a direct-write photolithographic technique. The focused beam also may be modulated or wobbled to define information such as encoded data, tracking servos, or the like, within the features of the master disk. After exposing the photoresist, a developer solution is used to remove either the exposed or unexposed photoresist, e.g., depending on whether a positive or negative photoresist material is used. In this development step, the latent exposure pattern is manifest as a topographical master pattern.

### SUMMARY

In general, the invention is directed to mastering techniques that can improve the quality of a master used in data storage disk manufacturing. In particular, the techniques described herein can reduce track pitch variations between adjacent tracks of the master. Also, the techniques may provide improved consistency in the features created on the master. Various mastering systems that can implement such techniques are also described.

In one embodiment, the invention is directed to a method of creating a data storage disk master comprising creating a plurality of focused laser spots, and simultaneously illuminating a photoresist layer of the master with the plurality of focused laser spots to photolithographically expose a plurality of tracks of the master. The plurality of focused laser spots may include three or more spots.

In another embodiment, the invention is directed to a method of creating a data storage disk master comprising creating an interference pattern from laser light, the interference pattern defining a plurality of constructive interference fringes, and simultaneously illuminating a photoresist layer of the master with the plurality of constructive interference fringes of the interference pattern to photolithographically expose a plurality of tracks of the master.

In various other embodiments, the invention may be directed to systems which implement the multi-spot mastering techniques or the interferometric mastering techniques described herein. Multiple passes of the focused laser spots or constructive interference fringes can be made relative to the master so as to expose each track of the master with a given one of the focused laser spots or the constructive interference fringes during an exposure pass. In still other embodiments, the invention may be directed to a data storage disk master having reduced track pitch variations relative to prior art masters, such as variations less than five nanometers, less than two nanometers, or even less than one nanometer. Such improvements in master pattern tolerances translate into improved stamper elements for optical disk fabrication and ultimately into disk replicas with improved quality. In other words, the stamper elements of an improved stamper created from the master described herein may have reduced track pitch variations relative to prior art stampers, such as track pitch variations less than five nanometers, less than two nanometers, or even less than one nanometer.

The invention may be capable of providing one or more advantages. For example, the described exposure techniques can improve track pitch variations by averaging the variation conventionally associated with the mastering system over the number of tracks that are simultaneously exposed. This reduces track pitch variations independently of mechanical deficiencies in the mastering system. Accordingly, track pitch variations less than five nanometers, less than two nanometers, or even less than one nanometer can be achieved. In addition, the exposure techniques described herein can improve the quality and consistency of created features by cumulating the optical exposure associated with each feature across each of the multiple photolithographic passes. The techniques can be used to create tracks of a spiral pattern or tracks of a concentric pattern.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a mastering system that may be used to implement the invention.

FIG. 2 is a block diagram illustrating mastering optics according to one embodiment of the invention.

FIG. 3 is a block diagram illustrating mastering optics according to another embodiment of the invention.

FIG. 4 is a block diagram illustrating mastering optics according to another embodiment of the invention.

FIGS. 5-9 are conceptual diagrams illustrating subsequent passes of mastering optics with respect to a master during the creation of the master.

FIG. 10 is a flow diagram illustrating a multi-spot mastering process according to an embodiment of the invention.

FIG. 11 is a flow diagram illustrating an interferometric mastering process according to an embodiment of the invention.

FIG. 12 is a conceptual diagram illustrating the translation of two four-spot passes in the creation of a concentric pattern.

FIG. 13 is a conceptual diagram illustrating the translation of two four-spot passes in the creation of a spiral pattern.

### DETAILED DESCRIPTION

The invention is directed to mastering techniques that can improve the quality of a master used in data storage disk manufacturing. In particular, the techniques described herein can reduce track pitch variations between adjacent tracks of the master. Also, the techniques may provide improved consistency in the features created on the master. Various mastering systems that can implement such techniques are also described.

A number of embodiments of the invention are described in greater detail below. In one embodiment, the invention comprises a multi-spot mastering technique in which a plurality of laser spots are focused onto the master disk. A photoresist layer of the master is simultaneously illuminated with the plurality of focused laser spots to photolithographically expose a plurality of tracks of the master. The plurality of focused laser spots are then translated relative to the master either continuously to expose a spiral pattern, or in discrete steps for a concentric pattern on the master disk, e.g., by an integer number of tracks for each subsequent revolution of the master disk. The photoresist layer of the master can be simultaneously illuminated again with the plurality of focused laser spots.

The translation of the plurality of focused laser spots can provide for overlapping sequential exposures of the tracks, such that each track is exposed by a different focused laser spot during each subsequent pass. In some cases, substantially all of the tracks of the master can be exposed by each of the focused laser spots, e.g., during subsequent iterative exposure passes. Such exposure techniques can improve track pitch variations by averaging the variation conventionally associated with the mastering system over the number of tracks that are simultaneously exposed. This reduces track pitch variations independently of mechanical deficiencies in the mastering system. In addition, the exposure techniques described herein can improve the quality and consistency of created features by cumulating the optical exposure associated with each feature across the multiple photolithographic passes.

In another embodiment, the invention comprises an interferometric mastering technique in which laser light is used to create an interference pattern, the interference pattern defining a plurality of constructive interference fringes. A photoresist layer of the master is then simultaneously illuminated with the plurality of constructive interference fringes of the interference pattern to photolithographically expose a plurality of tracks of the master. Each of the constructive interference fringes in the interference pattern provides exposure to the photoresist. Each intervening destructive interference fringe provides no exposure to the photoresist. The spaces between constructive and destructive fringes may provide partial exposure. In any case, the interference pattern is then translated relative to the master either continuously to form a spiral pattern or in discrete step to form a concentric pattern, e.g., by an integer number of tracks for each revolution of the master disk. For each subsequent revolution of the master disk, the photoresist layer of the master can be simultaneously illuminated again with the interference pattern.

In the interferometric mastering example, the translation of the interference pattern provides for the overlapping exposures of the tracks such that each track is exposed by different fringes of constructive interference pattern during each subsequent pass. In some cases, substantially all of the tracks of the master can be exposed by each of the constructive interference fringes of the interference pattern, e.g., during subsequent iterative exposure passes. Like the multi-spot mastering techniques, the interferometric mastering techniques can improve track pitch variations by averaging the variation associated with the mastering system over the number of tracks that are simultaneously exposed. In addition, the interferometric mastering techniques can improve the quality and consistency of created features by cumulating the optical exposure associated with each feature across multiple photolithographic passes.

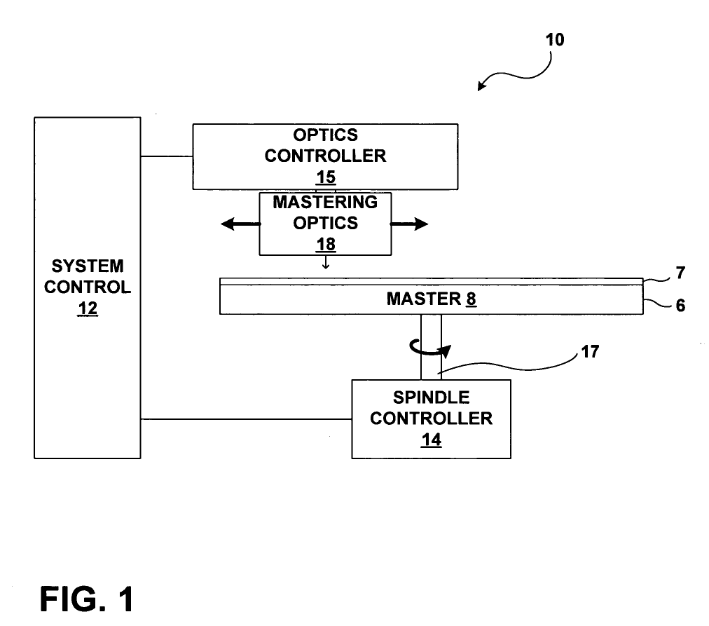

FIG. 1 is a block diagram illustrating a mastering system 10 that may be used to implement the invention. In general, mastering system 10 includes a system control 12, such as a personal computer, workstation, or other computer system. System control 12, for example, may comprise one or more processors that execute software to provide user control over system 10. System control 12 provides commands to spindle controller 14 and optics controller 15 in response to user input. The commands sent from system control 12 to spindle controller 14 and optics controller 15 define the operation of system 10 during the mastering process.

Data storage disk master 8 (hereafter “master”) may comprise a disk-shaped glass substrate 6 coated with a photoresist layer 7. Other substrate materials of suitable optical surface quality may also be used. In any case, master 8 is carefully placed in system 10 on spindle 17. Mastering optics 18 provide light that exposes photoresist layer 7 according to commands by system control 12.

Spindle controller 14 causes spindle 17 to spin master disk 8, while optics controller 15 controls the positioning of mastering optics 18 relative to master 8. Optics controller 15 also controls any on-off switching of light that is emitted from mastering optics 18. As master 8 spins on spindle 17, optics controller 15 translates mastering optics 18 to desired positions and causes mastering optics 18 to emit light that exposes photoresist layer 7.

As described in greater detail below, mastering optics 18 include features that can improve the mastering process. In particular, mastering optics 18 may include elements that allow for creation of multiple focused spots that can simultaneously illuminate photoresist layer 7 of master 8. Alternatively, mastering optics 18 may include elements that allow for creation of an interference pattern that includes a plurality of constructive interference fringes. In either case, system 10 can improve track pitch variations on master 8 by averaging the variation associated with the translation of mastering optics 18 over a number of tracks that are simultaneously exposed. In addition, the system 10 may improve the quality and consistency of created features by cumulating the optical exposure associated with each feature across multiple photolithographic passes. The embodiments described herein may be used with either positive photoresist or negative photoresist. In other words, the exposure of the photoresist by the multiple focused spots or the interference pattern can result in removal of the photoresist by a developer solution, or the exposure can result in the creation of features with the non-exposed areas being removed by a developer solution. In either case, master 8 can be created to have a plurality of tracks in which track pitch variations between adjacent tracks of the master are less than five nanometers, less than two nanometers, or even less than one nanometer.

Conventional optical mastering involves the scanning of a focused laser spot to record grooves at a precise track pitch. Limitations to mechanical systems, acoustical noise, laser pointing, and water and air flow turbulence are all sources of track-pitch-variations, which are typically on the order of 10 nanometers for state-of the-art mastering systems. For tightening track-pitch targets, the track-pitch variation requirements scale in proportion.

For historical reference, CD formats, recorded at 1.6 micron track pitch, required track pitch variation to be less than 50-100 nanometers (peak-to-peak). For DVD, where track pitch was decreased to 0.74 micron, the track pitch variation tolerance was reduced to 20-30 nanometers (peak-to-peak). For formats at 0.4 micron track pitch, the track pitch variation was required to be 10-15 nanometers (peak-to-peak). As the trend for reduced track pitch continues, track pitch variations may approach limits of conventional mastering controllers and conventional mastering optics.

In conventional optical mastering, the focused laser spot, with a roughly Gaussian intensity distribution, illuminates the photoresist-coated master substrate to initiate a photoreaction. The following paragraphs are illustrative of the relationship of the point-by-point exposure intensity in the photoresist and the resulting topography in the developed surface of the master. The important observation of the following analysis is not in the specific form of the models, but in the fact that exposure is cumulative at any point in the photoresist. Thus, the cumulative exposure dictates the resulting surface of the master.

After exposure, the normalized photoactive compound (M(X,Y,Z)) remaining in the photoresist is typically given by:
M(X,Y,Z)=exp((−C*E((X,Y,Z)
where E(X,Y,Z) is the cumulative exposure dose received at spatial coordinate (X,Y,Z) and C is a parameter characterizing the quantum efficiency of the photoreaction.

The subsequent dissolution rate in the developer solution is typically given by Rate[nanometers/second]=Ro*[(1−M(X,Y,Z))\hat{ }q+Rb],

where Ro is the dissolution rate of a fully exposed photoresist,

Rb is the dissolution rate of a unexposed photoresist, and
q is a parameter related to the photoresist contrast.
Typical values for these parameters are: q=3; 10<Rb<200; and Rb=0.

For optical mastering, the photoresist coatings are typically less than 200 nanometers. At these small thicknesses one can approximate that the normalized photo-active compound (M(X,Y,Z)) is uniform through the thickness dimension of the photoresist layer. Thus, M(X,Y,Z) can be effectively approximated by M(X,Y). Given these approximations, the dissolution rate in the developer solution becomes:
Rate [nm/sec]=Ro(1−M(X,Y))\hat{ }q
and the final resist thickness becomes:
Tfinal=Tinitial−Rate*(development time), or
Tfinal=Tinitial−Ro*(1−exp(−CE(X,Y)))\hat{ }q*(development time)

Again, the importance of this analysis is not in the specifics of the forms assumed for the models, but rather in the result that the final thickness (for any given point) depends only the initial thickness and the cumulative exposure seen by that portion of the master (E(X,Y)). In the case of conventional mastering, any given point in the resist is exposed by a single pass of a focused beam to illuminate the region in one pass (i.e., one rotation) of the master in the mastering system.

As described herein, this invention describes utilization of the cumulative exposure effects of the photoresist materials and a multi-spot recording system. In particular, N distinct focused laser spots (or unfocused points of constructive interference) provide an “averaging” of the mechanical track pitch variation capability of a single spot system. In one example, a single beam is broken up into a plurality, e.g. 20, equally spaced beams which are all brought into focus on the photoresist at integer multiples of the desired track pitch. The resulting contribution to the cumulative exposure from each beam would then be e.g. 1/20th of that which would be considered normal for a single beam. However, the cumulative exposure once the 20 spots had all passed a given region of the medium would be the same. The cumulative exposures have the effect of averaging the track pitch variation.

For example, if the standard deviation of the conventional system is defined as “sigma” and the multi-spot “averaged” standard deviation as “sigma*,” then, the result (sigma*) is expected to be improved in comparison with the standard deviation of track pitch variation (sigma) of conventional system to better than
sigma*<[sigma/(N)\hat{ }0.5.]

One potential disadvantage of the proposed system is the inability of the multi-spot beam to uniquely label an individual recorded groove with wobble-addressing information. Unique marking or wobbling of a specific track is inherently at odds with the track pitch variation averaging. It is possible, however, that this shortcoming could be circumvented with either a second pass recording over the master surface or a secondary beam assigned just to the task of pre-formatting or wobble formatting. In other words, another etching pass using conventional optics may be performed to provide formatting information to individual tracks, after implementing the techniques described herein to define the tracks with improved track pitch variations.

The implementation of this multi-spot mastering may be accomplished by a transmissive or reflective type diffraction grating or possibly with a spatial light modulator device. Alternatively, an interference pattern can be defined to have defined constructive interference fringes which essentially function as the multiple focused spots of the previous embodiments. In the interferometric case, however, the light is not focused on the photoresist, but rather, the intersection zone of the two broadly collimated laser beam components define the area of constructive interference and destructive interference on the photoresist.

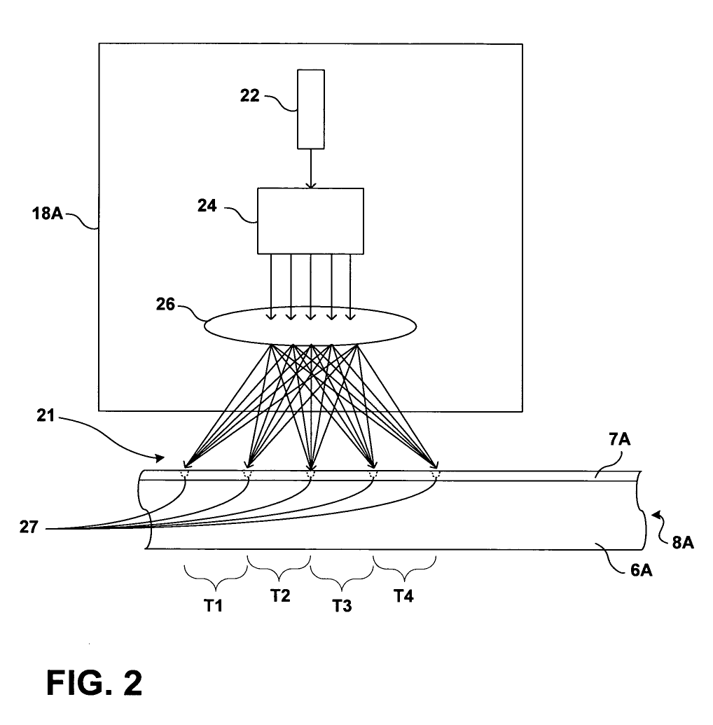

FIG. 2 is a block diagram illustrating one embodiment of mastering optics 18A which may correspond to mastering optics 18 in FIG. 1. Also depicted in FIG. 2 is a portion of master 8A comprising a substrate 6A coated with a photoresist layer 7A. In accordance with the invention, mastering optics 18A creates a plurality of three or more equally-spaced and precisely focused laser spots 21 and simultaneously illuminates photoresist layer 7A of master 8A with the plurality of focused laser spots 21 to photolithographically expose a plurality of tracks of master 8A. In the illustrated example, five different focused laser spots 21 are created, although any number may be created in accordance with the invention.

Mastering optics 18A includes a laser 22 that produces laser light. The laser light is segmented into a plurality of beams using element 24. For example, element 24 may comprise a diffraction grating, a holographic grating, or any other element that can segment a single light beam into a plurality of beams. The plurality of beams are optically directed by one or more lenses 26 or other optical elements to focus each of the plurality of beams and define focused laser spots 21. The focused laser spots simultaneously illuminate photoresist layer 7A of master 8A to expose a plurality of tracks of the master. Mastering optics 18A can then be translated in either continuous manner for spiral pattern or in discrete steps relative to master 8A so that during a subsequent pass, focused laser spots 21 expose a different set of tracks some of which may be the same as those exposed during the first pass.

By performing multiple passes of focused laser spots 21 such that each of the focused laser spots 21 makes a single pass through each track, the track pitch variations on master 8A are averaged across the variation associated with the translation of mastering optics 18A. In other words, if the translation of mastering optics 18A has a variation of X, the variation in track pitch on master 8A will be approximately X/(5)\hat{ }1/2 since five focused laser spots 21 are created. The track pitch is represented by each of T1, T2, T3 and T4. Variations between any of T1, T2, T3 and T4 generally define the track pitch variation. Mastering optics 18A can facilitate the creation of features 27 having a track pitch variation less than five nanometers, less than two nanometers, or even less than one nanometer.

In addition, the quality and consistency of created features 27 can be improved by cumulating the optical exposure associated with each of features 27 across multiple photolithographic passes. In other words, each of features 27 is exposed to each of the focused laser spots 21 during various passes of mastering optics 18A relative to master 8A. For each subsequent pass, mastering optics 18A are translated to form either spiral or concentric pattern relative to master 8A so as to expose a unique set of tracks with each pass, some of which may have been exposed during previous passes. If desired, however, two or more passes may be performed at each translated location.

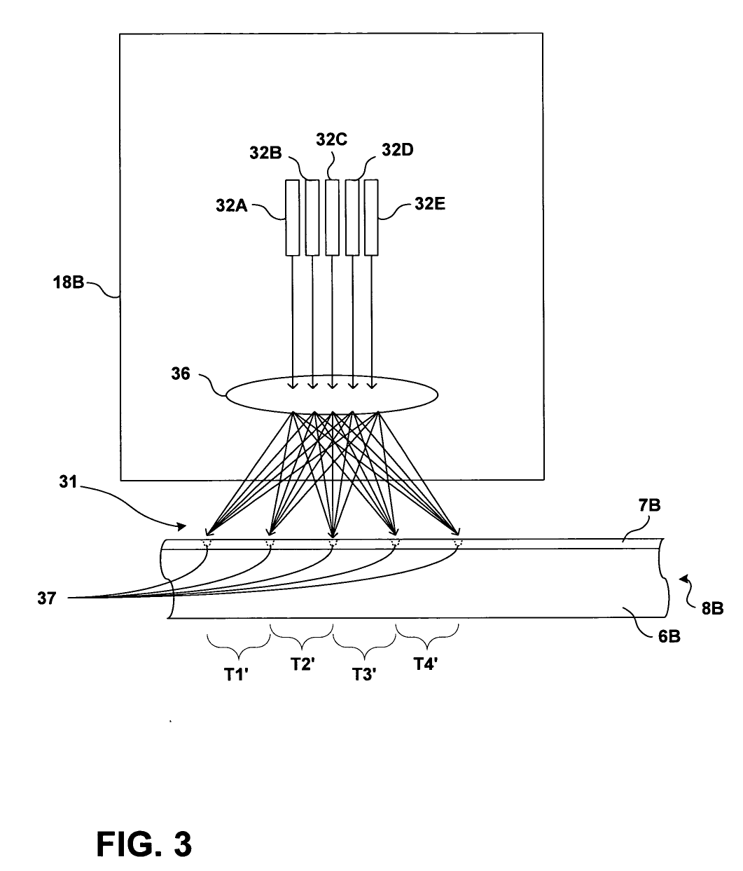

FIG. 3 is a block diagram illustrating another embodiment of mastering optics 18B which may correspond to mastering optics 18 in FIG. 1. Also depicted in FIG. 3 is a portion of master 8B comprising a substrate 6B coated with a photoresist layer 7B. In accordance with the invention, mastering optics 18B creates a plurality of focused laser spots and simultaneously illuminates photoresist layer 7B of master 8B with the plurality of focused laser spots to photolithographically expose a plurality of tracks of the master. Like the embodiment of FIG. 2, in the example of FIG. 3, five different focused laser spots 31 are created, although any number may be created in accordance with the invention.

In the embodiment illustrated in FIG. 3, however, multiple different lasers 32A-32E, e.g., from a laser diode array, create the multiple different beams. The plurality of beams are optically directed by one or more lenses 36 or other optical elements to focus each of the plurality of beams and define focused laser spots 31. The focused laser spots simultaneously illuminate photoresist layer 7B of master 8B to expose a plurality of tracks of the master. Mastering optics can then be translated to form either spiral or concentric pattern relative to master 8B so that during a subsequent pass, focused laser spots 31 expose a different set of tracks some of which may be the same as those exposed during the first pass.

Again, by performing multiple passes of focused laser spots 31 such that each of the focused laser spots 31 makes a single pass through each track, the track pitch variations on master 8B are averaged across the variation associated with the translation of mastering optics 18A. Also, the quality and consistency of created features 37 can be improved by cumulating the optical exposure associated with each of features 37 across multiple photolithographic passes. In the example illustrated in FIG. 3, the track pitch is represented by each of T1′, T2′, T3′ and T4′. Variations between any of T1′, T2′, T3′ and T4′ generally define the track pitch variation. Mastering optics 18B can facilitate the creation of features 37 having a track pitch variation less than five nanometers, less than two nanometers, or even less than one nanometer.

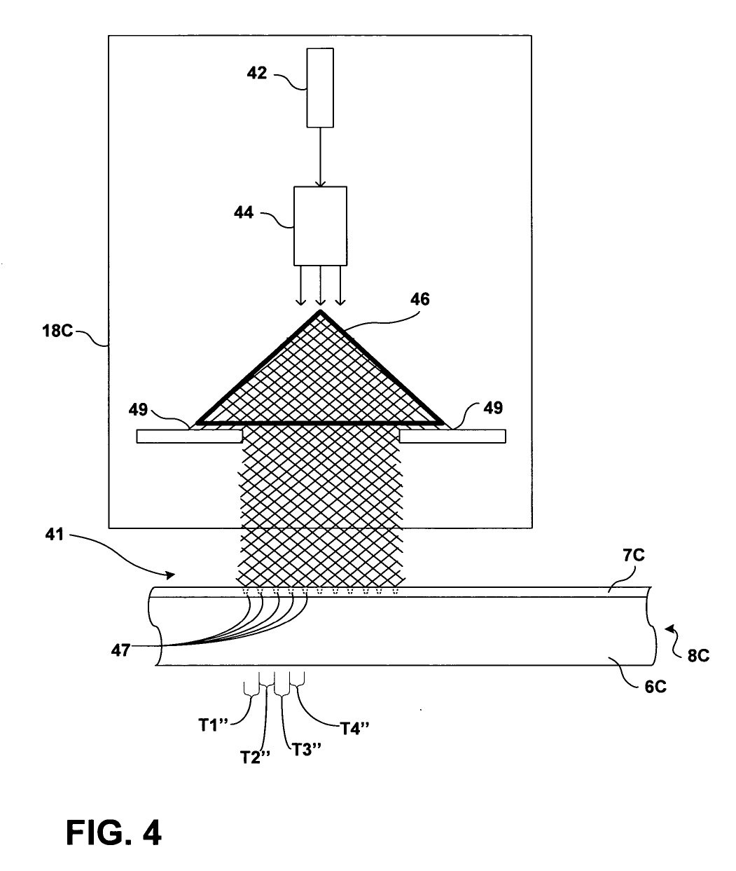

FIG. 4 is a block diagram illustrating yet another embodiment of mastering optics 18C which may correspond to mastering optics 18 in FIG. 1. Also depicted in FIG. 4 is a portion of master 8C comprising a substrate 6C coated with a photoresist layer 7C. In this embodiment, mastering optics 18C creates an interference pattern 41 from the intersection of two broadly collimated laser beam portions directed onto photoresist layer 7C. Interference pattern 41 is created to define constructive interference fringes, which are analogous to focused laser spots of previous embodiments. In the areas between the constructive interference fringes, however, are areas of destructive interference. Thus, the points of constructive interference within interference pattern 41 define the points or fringes of exposure of photoresist layer 7C on master 8C and the points of deconstructive interference within the interference pattern define the points or fringes of non-exposure of the photoresist layer. In the illustrated example, five different constructive interference fringes are created, although any number may be created in accordance with the invention. For interferometric mastering, in particular, hundreds, or even thousands of constructive interference fringes may be created with precise spacing between the fringes dictated by the recording laser wavelength and the angles of intersection of the two interfering beam components.

Mastering optics 18C includes a laser 42 that produces laser light. The laser light is expanded and collimated using collimator 44. For example, collimator 44 may comprise a set of lenses or other optical elements that create an expanded and collimated band of laser light. The light exiting collimator 44 may be refracted by prism 46 or directed by other means to form an intersection zone of two component collimated beams to create an interference pattern on the photoresist. For example, an arrangement of beam splitters and mirrors may alternatively be used to create the interference pattern. Alternatively, the laser beam may be directed through the substrate to the substrate-resist interface to create an evanescent interference pattern. A mask 49 can also be added to avoid peripheral light from illuminating master 8C and define illumination area.

In any case, interference pattern 41 specifically defines points of constructive interference fringes, which simultaneously illuminate photoresist layer 7C of master 8C to expose a plurality of tracks of master 8C. Mastering optics 18C can then be translated relative to master 8C either continuously for spiral pattern generation or in discrete steps for concentric pattern generation so that during a subsequent pass, the points of constructive interference expose a different set of tracks, some of which may be the same as those exposed during the first pass.

Like in the multi-spot embodiments, by performing multiple passes of interference pattern 41 such that each of the constructive points of interference makes a single pass through each track, the track pitch variations on master 8C are averaged across the variation associated with the translation of mastering optics 18C. In other words, if the translation of mastering optics 18C has a variation of X, the variation in track pitch on master 8A will be approximately X/(N)\hat{ }1/2 where N is the number of constructive interference fringes. The track pitch, in this example, are represented by each of T1″, T2″, T3″ and T4″. Variations between any of T1″, T2″, T3″ and T4″ generally define the track pitch variation. Mastering optics 18C can facilitate the creation of features 47 having a track pitch variation less than five nanometers, less than two nanometers, or even less than one nanometer. Only a subset of features 47 are labeled for simplicity.

The quality and consistency of created features 47 can be improved by cumulating the optical exposure associated with each of features 47 across multiple passes of the interference pattern. In other words, each of features 47 is exposed to each of the constructive points of interference during various passes of mastering optics 18C relative to master 8C. For each subsequent pass, mastering optics 18C are translated either continuously for a spiral pattern or in discrete steps for a concentric pattern relative to master 8C so as to expose a unique set of tracks with each pass, some of which may have been exposed during previous passes/rotations. If desired, however, two or more passes may be performed for each translated location.

When multi-spot mastering is implemented, the creation of the plurality of focused laser spots may comprise creating a one-dimensional array of focused laser spots. Alternatively, a two-dimensional array of focused laser spots can be created, which would be oriented relative to the master to define various tracks of the master. When interferometric mastering is implemented in simplest form, the interference pattern is inherently comprised of a one-dimensional array of constructive interference fringes. A two-dimensional array of constructive interference fringes may be comprised of 4 balanced intensity beams interfering in the photoresist layer.

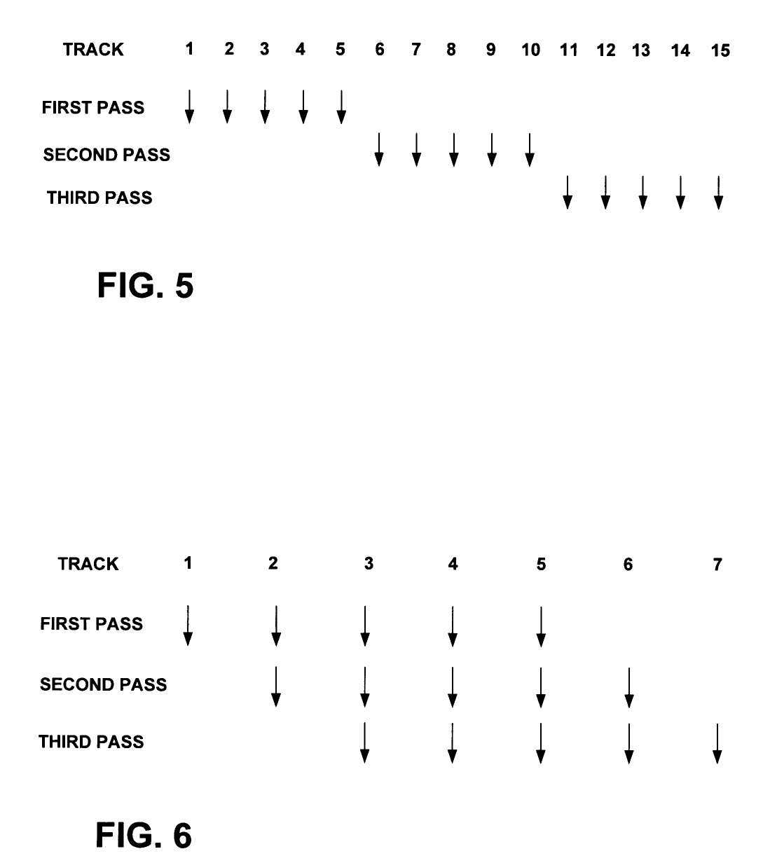

FIG. 5 is a conceptual diagram illustrating three passes of mastering optics 18 with respect to master 8. Master 8 spins beneath mastering optics 18, as mastering optics 18 translate along a radial dimension of master 8 and perform any on-off switching of the light which illuminates and exposes photoresist layer 7. Each of the arrows depicted in FIG. 5 represent either one of a plurality of focused laser spots, or one of a plurality of constructive interference fringes of an interference pattern.

In either case, the spots or points expose a first set of tracks (tracks 1-5) during a first pass. The spots or points are then translated so that during a second pass, the spots or points expose a second set of tracks (tracks 5-10). The spots or points are then translated again so that during a third pass, the spots or points expose a third set of tracks (tracks 11-15). This process can continue over substantially the entire surface of master 10.

FIG. 6 is another conceptual diagram illustrating three passes of mastering optics 18 with respect to master 8. Again, master 8 spins beneath mastering optics 18 as mastering optics 18 translate along a radial dimension of master 8 and perform any on-off switching of the light which illuminates and etches photoresist layer 7. Each of the arrows depicted in FIG. 6 represent either one of a plurality of focused laser spots, or one of a plurality of constructive interference fringes of an interference pattern.

In either case, the spots or fringes expose a first set of tracks (tracks 1-5) during a first pass. The spots or fringes are then translated by one track so that during a second pass, the spots or fringes expose a different set of tracks (tracks 2-6). Thus, during the second pass, mastering optics 18 re-expose some of the tracks exposed during the first pass. The spots or fringes are then translated again so that during a third pass, the spots or fringes expose another different set of tracks (tracks 3-7). This process can continue over substantially the entire surface of master 10, translating by one track with every pass.

FIG. 7 is another conceptual diagram illustrating four passes of mastering optics 18 with respect to master 8. Again, master 8 spins beneath mastering optics 18, as mastering optics 18 translate along a radial dimension of master 8 and perform any on-off switching of the light which illuminates and etches photoresist layer 7. Each of the arrows depicted in FIG. 7 represent either one of a plurality of focused laser spots, or one of a plurality of constructive interference fringes of an interference pattern.

In either case, the spots or fringes expose a first set of tracks (tracks 1, 3, 5, 7 and 9) during a first pass. The spots or fringes are then translated by one track so that during a second pass, the spots or fringes expose a different set of tracks (tracks 2, 4, 6, 8 and 10). Thus, during the second pass, mastering optics 18 expose a different set of tracks than those exposed during the first pass. The spots or fringes are then translated again so that during a third pass, the spots or fringes expose another different set of tracks (tracks 3, 5, 7, 9 and 11). Thus, during the third pass, some of the tracks exposed during the first pass are re-exposed. This process can continue over substantially the entire surface of master 10, translating by one track with every pass.

FIG. 8 is another conceptual diagram illustrating five passes of mastering optics 18 with respect to master 8. Again, master 8 spins beneath mastering optics 18, as mastering optics 18 translate along a radial dimension of master 8 and perform any on-off switching of the light which illuminates and etches photoresist layer 7. Each of the arrows depicted in FIG. 8 represent either one of a plurality of focused laser spots, or one of a plurality of constructive interference fringes of an interference pattern.

In either case, the spots or fringes expose a first set of tracks (tracks 1, 5, and 9) during a first pass. The spots or fringes are then translated by one track so that during a second pass, the spots or fringes expose a different set of tracks (tracks 2, 6, and 10). Thus, during the second pass, mastering optics 18 expose a different set of tracks than those exposed during the first pass. The spots or fringes are then translated by one track so that during a third pass, the spots or fringes expose a different set of tracks (tracks 3, 7, and 11). During a fourth pass, tracks 4, 8 and 12 are exposed. During a fifth pass, tracks 5, 9 and 13 are exposed. Thus, in this case, during the fifth pass, some of the tracks exposed during the first pass are re-exposed. This process can continue over substantially the entire surface of master 10, translating by one track with every pass.

The embodiments illustrated in FIGS. 5-8 illustrate one-dimensional arrays of spots or constructive interference fringes. FIG. 9 is a conceptual diagram illustrating a two-dimensional array created by mastering optics 18, making three passes with respect to master 8. Each of the arrows depicted in FIG. 9 represent either one of a plurality of focused laser spots, or one of a plurality of constructive interference fringes of an interference pattern. As shown, the pattern of spots or fringes of constructive interference comprise a two-dimensional array.

Again, master 8 spins beneath mastering optics 18, as mastering optics 18 translate along a radial dimension of master 8 and perform any on-off switching of the light which illuminates and etches photoresist layer 7. The spots or fringes expose a first set of tracks (tracks 1-9) during a first pass. The spots or fringes are then translated by one track so that during a second pass, the spots or fringes expose a different set of tracks (tracks 2-10). Thus, during the second pass, mastering optics 18 re-expose some of the tracks exposed during the first pass. The spots or fringes are then translated again so that during a third pass, the spots or fringes expose another different set of tracks (tracks 3-11). This process can continue over substantially the entire surface of master 10, translating by one track with every pass.

As illustrated in FIGS. 5, 6 and 9, the created master can define a track width equal to a distance between each of the plurality of focused laser spots or the plurality of constructive interference fringes. Alternatively, as illustrated in FIGS. 7 and 8, the created master can define a track width less than a distance between each of the plurality of focused laser spots or the plurality of constructive interference fringes. In other words, the distance between each of the plurality of focused laser spots or the plurality of constructive interference fringes may correspond to an integer number of tracks on the master. Each translation, however, typically moves the spots or points by a single track relative to the surface of master per revolution of the master disk.

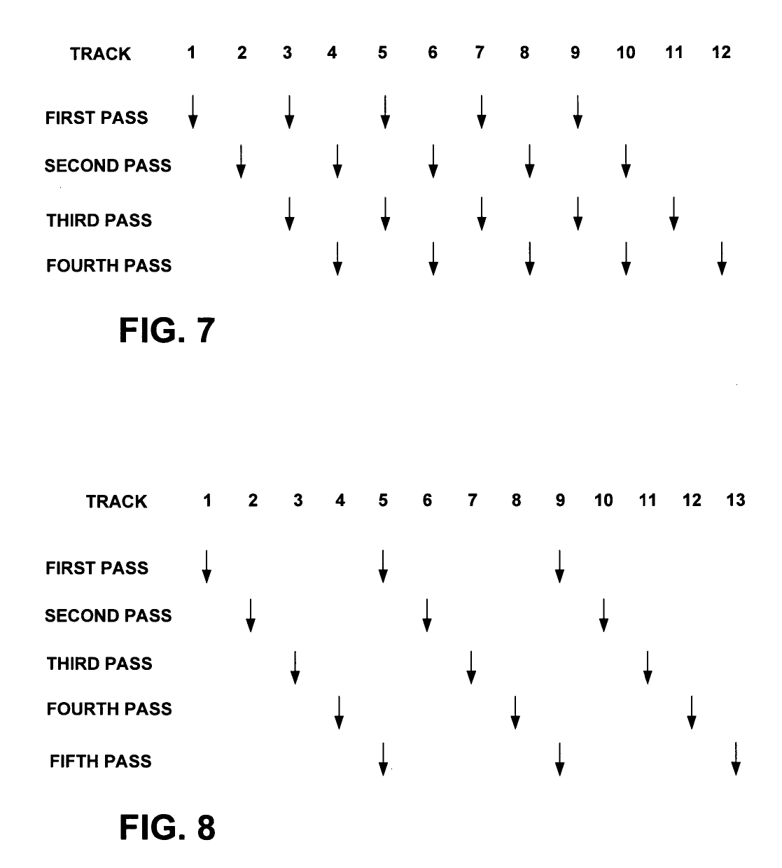

FIG. 10 is a flow diagram illustrating a multi-spot mastering process according to an embodiment of the invention. As shown, mastering optics 18 create a plurality of laser spots (101), e.g., using a single laser which is separated into multiple beams as shown in FIG. 3 or multiple laser as shown in FIG. 4. Photoresist layer 7 is illuminated with the laser spots to simultaneously expose multiple tracks of master 8 (102). Mastering optics 18 are then translated relative to master 8, thereby translating the laser spots relative to master 8 (103) to form either a spiral or concentric master pattern. For each revolution of the master disk photoresist layer 7 is again illuminated with the laser spots to simultaneously expose multiple tracks of master 8 (102). The equidistant spacing of the focused laser spots may correspond to an integer number of tracks, and the translations may move the spots relative to master 8 by a single track for each pass. In some cases, however, multiple passes can be made at each position before performing a translation. In any case, the translation and exposure steps repeat until the desired tracks are created over substantially the entire surface of master 8. The translation and exposure steps may be continuous to define a spiral pattern or step-wise to define a concentric pattern.

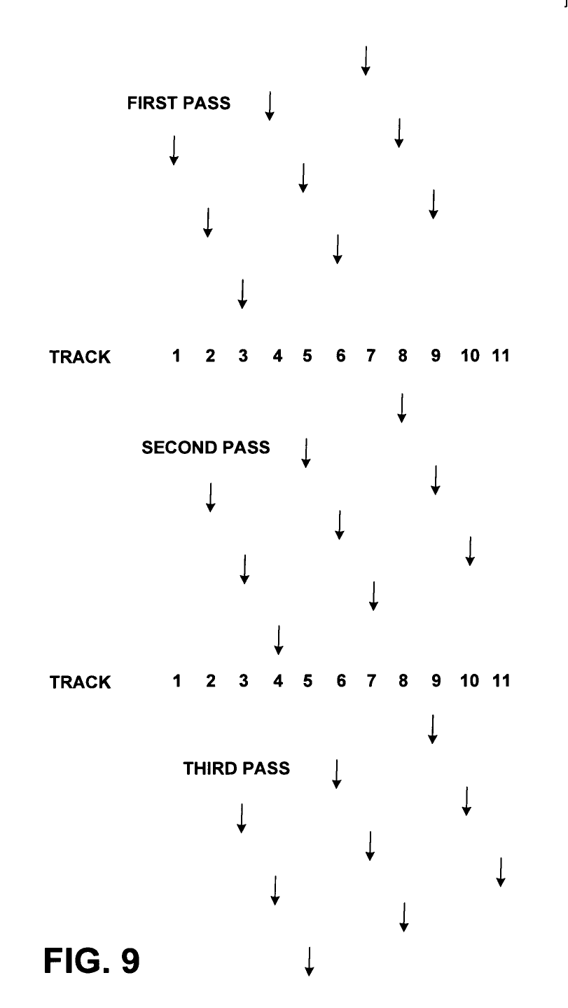

FIG. 11 is a flow diagram illustrating an interferometric mastering process according to an embodiment of the invention. As shown, mastering optics 18C create an interference pattern 41 with a plurality of points of constructive interference fringes (111). Photoresist layer 7C is illuminated with interference pattern 41 to simultaneously expose multiple tracks of master 8C (112). The mastering optics are then translated relative to master 8C, thereby translating interference pattern 41 relative to master 8C (113). Photoresist layer 7C is again illuminated with interference pattern 41 to simultaneously expose multiple tracks of master 8C (112).

In contrast to the multi-spot embodiments, the periodic nature of the interference pattern dictates the equal widths of the constructive and destructive fringes. As such, the spacing of constructive interference fringes corresponds inherently to the mastering track pitch for a mastered pattern using continuous translation for spiral generation. Though possible, mastering a spiral pattern at a track pitch shorter than the spacing of constructive interference fringes would require two or more translations across the master disk surface and compromises exposure contrast in the resist. Concentric mastering involves discrete translation steps of any integer number of tracks, and the translations may move the spots relative to master 8C by a single track for each pass or multiple tracks for each pass. In some cases, however, multiple passes can be made at each position before performing a translation. In any case, the translation and exposure steps repeat until the desired tracks are created over substantially the entire surface of master 8C.

The translation of the plurality of focused laser spots or the plurality of constructive interference fringes of an interference pattern can provide for overlapping sequential exposures of the tracks, such that each track is exposed by a different focused spot or constructive interference fringe during each subsequent pass. Such exposing techniques can improve track pitch variations by averaging the variation conventionally associated with the mastering system over the number of tracks that are simultaneously exposed. This reduces track pitch variations independently of mechanical deficiencies in the mastering system. In addition, the exposing techniques described herein can improve the quality and consistency of created features by cumulating the optical exposure associated with each feature exposed during each of the multiple photolithographic passes.

As described herein, the translation between each subsequent pass can be continuous to create a spiral pattern, or step-wise to create a concentric pattern. In the former case, the illumination is continuous for each subsequent pass, and in the later case, on-off switching occurs between each translation.

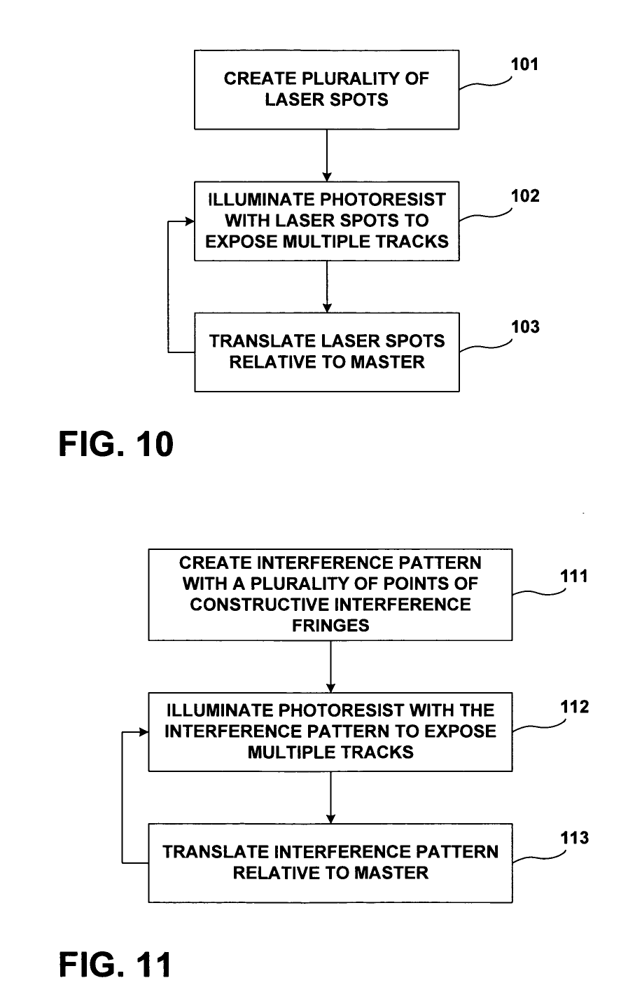

FIG. 12 is a conceptual diagram illustrating the translation of two four-spot passes in the creation of a concentric pattern. In this case, four spots (or fringes) are illustrated as A, B, C and D. During the first pass, the spots (or fringes) create four concentric tracks. The illumination is then switched off, translated one track, and switched back on. Thus, during the second pass, the spots (or fringes) A, B, C and D expose four different concentric tracks, three of which are the same tracks being exposed by different spots (or fringes).

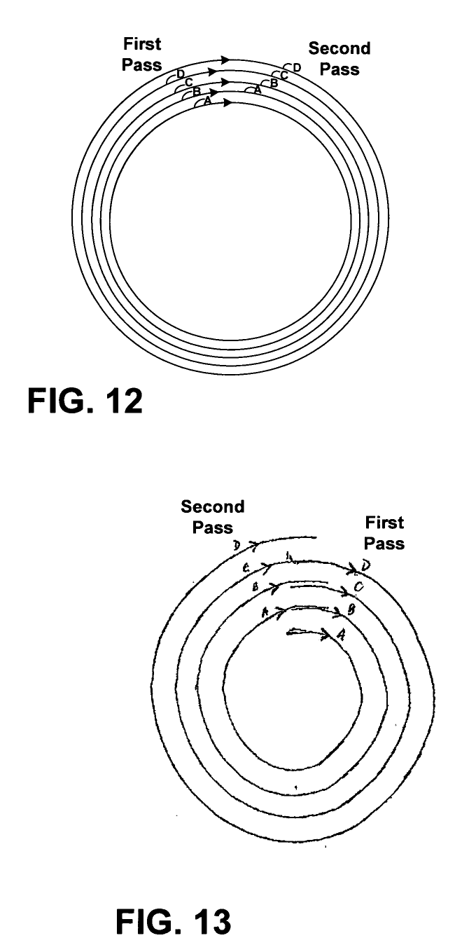

FIG. 13 is a conceptual diagram illustrating the translation of two four-spot passes in the creation of a spiral pattern. In this case, four spots (or fringes) are again illustrated as A, B, C and D. However, in this case, the translation is continuous, creating a spiral pattern. During the first pass, the spots (or fringes) create four tracks. During the second pass, the spots (or fringes) A, B, C and D expose four different tracks of the spiral pattern, three of which are the same tracks being exposed by different spots (or fringes). The spiraling effect is continuous, thereby creating a spiral pattern over substantially the entire surface of the master without requiring any on-off switching of the illumination.

Various embodiments of the invention have been described. For example, multi-spot mastering techniques and interferometric mastering techniques have been described for the creation of data storage disk masters. Such masters are useful in creating optical media, or other media such as patterned media or patterned magnetic media or optical elements such as diffractive optical elements or reference gratings. The multi-spot mastering techniques and the interferometric mastering techniques are analogous, yet different. In both cases, multiple tracks are simultaneously exposed. With multi-spot mastering, a plurality of laser beams are created and focused on the master to expose the photoresist layer. With interferometric mastering, two broadly collimated laser beams intersect to interfere in the photoresist layer to provide an interference pattern having points of constructive and destructive interference fringes. Either case, however, can improve track pitch variations in data storage disk masters and can also provide for improved features on the master by taking advantage of cumulative exposures of each track.

In the description above, the multi-spot mastering techniques or interferometric mastering techniques have been described as being performed over substantially the entire surface of the master. In some cases, however, innermost or outermost tracks may be exposed to only some of the passes. Accordingly, the phrase “substantially the entire surface of the master” is meant to encompass scenarios where the innermost or outermost tracks are not necessarily exposed to every spot or point. In that case, the innermost or outermost tracks may have smaller feature depths because of fewer exposure passes to those tracks.

Nevertheless, various modifications can be made to the techniques described herein without departing from the spirit and scope of the invention. For example, the same or similar techniques may be used with non-photolithographic sources, i.e., electron beams, ion-beams, probe beams, or the like. In that case, methods may include creating a plurality of three or more equally spaced beams, and simultaneously illuminating a master with the plurality of beams. These and other embodiments may be within the scope of the following claims.

1. A method of creating a data storage disk master:
creating a plurality of three or more equally spaced and focused laser spots; and
simultaneously illuminating a photoresist layer of the master with the plurality of focused laser spots to photolithographically expose a plurality of tracks of the master.

2. The method of claim 1, further comprising creating the plurality of focused laser spots from a single laser by optically separating light from the laser into a plurality of light beams corresponding to the plurality of focused laser spots.

3. The method of claim 1, further comprising creating the plurality of focused laser spots using a plurality of different lasers.

4. The method of claim 1, wherein creating the plurality of focused laser spots comprises creating a one-dimensional array of focused laser spots.

5. The method of claim 1, wherein creating the plurality of focused laser spots comprises creating a two-dimensional array of focused laser spots.

6. The method of claim 1, further comprising simultaneously illuminating the photoresist layer of the master a plurality of times with the plurality of focused laser spots.

7. The method of claim 1, further comprising:
translating the plurality of focused laser spots relative to the photoresist layer by an integer number of the tracks; and
simultaneously illuminating the photoresist layer of the master with the plurality of focused laser spots to photolithographically expose a different plurality of tracks of the master.

8. The method of claim 7, further comprising:
repeatedly translating the plurality of focused laser spots relative to the photoresist layer by the integer number of the tracks over substantially an entire surface of the master; and
repeatedly simultaneously illuminating the photoresist layer of the master with the plurality of focused laser spots over substantially the entire surface of the master.

9. The method of claim 8, wherein track pitch variations on the master are less than five nanometers.

10. The method of claim 7, wherein the master defines a track width equal to a distance between each of the plurality of focused laser spots.

11. The method of claim 7, wherein the master defines a track width less than a distance between each of the plurality of focused laser spots.

12. A method of creating a data storage disk master:
creating an interference pattern from laser light, the interference pattern defining a plurality of constructive interference fringes; and
simultaneously illuminating a photoresist layer of the master with the plurality of constructive interference fringes of the interference pattern to expose a plurality of tracks of the master.

13. The method of claim 12, wherein creating the interference pattern comprises creating an interference pattern that includes the plurality of constructive interference fringes in a one-dimensional array.

14. The method of claim 12, wherein creating the interference pattern comprises creating an interference pattern that includes the plurality of constructive interference fringes in a two-dimensional array.

15. The method of claim 12, further comprising creating the interference pattern using a prism.

16. The method of claim 12, further comprising simultaneously illuminating the photoresist layer of the master a plurality of times with the interference pattern.

17. The method of claim 11, further comprising:
translating the plurality of constructive interference fringes of the interference pattern relative to the photoresist layer by an integer number of the tracks; and
simultaneously illuminating the photoresist layer of the master with the interference pattern to expose a different plurality of tracks of the master.

18. The method of claim 17, further comprising:
repeatedly translating the plurality of constructive interference fringes of the interference pattern relative to the photoresist layer by an integer number of the tracks over substantially an entire surface of the master; and
repeatedly simultaneously illuminating the photoresist layer of the master with the interference pattern over substantially the entire surface of the master, wherein track pitch variations on the master are less than five nanometers.

19. The method of claim 17, wherein the master defines a track width equal to a distance between each of the plurality of constructive interference fringes of the interference pattern.

20. The method of claim 17, wherein the master defines a track width less than a distance between each of the plurality of constructive interference fringes of the interference pattern.
